(19) United States
(12) Patent Application Publication
(10) Pub. No.: US 2007/0295701 A1
(43) Pub. Date: Dec. 27, 2007

(54) Novel Plasmatorch and Its Application in Methods for Conversion of Matter

(76) Inventors: Laszlo Gyula Bodroghkozy, Budapest (HU); Laszlo Geza Kozeky, Budapest (HU)

Correspondence Address: YOUNG & THOMPSON, 745 SOUTH 23RD STREET, 2ND FLOOR, ARLINGTON, VA, 22202, US

(21) Appl. No.: 11/578,968

(22) PCT Filed: Apr. 19, 2005
(86) PCT No.: PCT/HU05/00039

§ 371 Date: Apr. 18, 2007

(30) Foreign Application Priority Data
Apr. 19, 2004 (HU) P 0400808

(51) Int. Cl. H05H 1/32; H05H 1/42; H05H 1/48

(52) U.S. Cl. 219/121.52; 219/121.59

(57) ABSTRACT

The present invention relates to a novel plasmatorch (1) and to its application within the field of chemicophysical conversion of matter The plasmatorch (1) comprises a pair of electrodes apart from each other, a plasma arc (10) existing between the two electrodes and a collimator (14) arranged for converging the plasma arc (10). The arcing material is stored within a special storage tank and is realised by a metal vapour, preferably by the vapour of an alkali or an alkali-earth metal.

The present invention relates to a novel plasma torch and to the possible applications thereof.

In nature plasma is the most common state of a material. The term ‘plasma’ refers to an ionized gas in which the great majority of atoms lost one or more of their electrons and hence became positive ions. The plasma, in fact, is a mixture of three components: positive ions, free electrons, and neutral atoms (maybe molecules). The plasma is a quasi-neutral medium in which the concentration of electrons and that of ions are about equal. Within the plasma, electric forces act between the charged particles, hence it is a dynamical system which is subjected to electromagnetic forces.

In practice, plasma occurs in various gas discharges (eg. sparks, lightning strokes, arcs). From industrial and scientific aspects the quasi-neutral and quasi-stationary plasma arcs of high temperatures are of great importance, as well as their applications for example in the fields of metallurgy, vitrification processes, energy production, disposal of dangerous wastes and recycling gasification of organic materials being decomposed at high temperatures and of plastic materials with high halogen content.

Plasmaenergy arc smelters (or plasma furnaces) in which the arc forming temperature can be controlled very accurately even at relatively high (about 10,000° C.) arc temperatures and wherein the atmosphere of the furnace can be varied are known nowadays. A major drawback of plasma furnaces equipped with a plasma torch (or of the similar apparatuses) is that in these equipments the torch forms merely an extremely well-controllable heat source (a melting arc), that is, it acts solely as a heater. The heat input that serves for incandescing the material to be subjected to a metallurgical process (from now the target) takes place in the form of a heavy radiation heat transfer, as well as a resistance heating due to the closing of the arc through the anode and the target acting as the cathode.

The output of plasma torches applied in the plasma furnaces approaches nowadays the value of 2.5 MW, and due to improvements, the electrodes' overall lifetime has been raised to about 1,000 hours. Nevertheless, further increase in the output of the plasma torches is impeded by technical difficulties; at the moment maintenance of the plasma arc, achieving a suitable degree of ionization of the arcing gas and cooling of the constructional elements of the plasma torch are unsolved at higher outputs. Up to now, no such plasma torch has been constructed, wherein the continuous consumption of the positive electrode, i.e. of the anode, would not limit the overall lifetime of the plasma torch and hence that of the plasma furnace. To replace the consumable anode, in given periods of time the plasma furnace should be stopped which significantly increases the operating costs of this type of furnaces.

Furthermore, in plasma torches used nowadays nitrogen, air (also containing nitrogen), argon, hydrogen, helium, methane or propane is used as the arcing gas. When said arcing materials recooled from the plasma state after having interacted with the target (i.e. after heat transfer with the target), they mix up with the vapours/gases exiting the target, in many instances they also react with them and then together with these vapours/gases they either leave the reaction volume through a gas scrubber/gas cleaner system or (eg. in case of plasma furnaces) get incorporated into the residual slag. In most cases the obtained products are highly polluting, hence their recycling or at least their disposal should be solved which also increases the operating costs of the plasma torches at issue. For example, today's most well-spread plasma torches that use nitrogen or air as the arcing gas produce a great deal of nitrous fumes (eg. NOₓ) as byproducts, which fumes are excessively environmental polluting and unhealthy. The incorporation of these materials into slag and/or their filtering out by means of gas scrubber/gas cleaner systems do not lead to the expected result, as a consequence of which the NOₓ, emission of traditional plasma torches exceeds the limits prescribed by the environmental measures.

A further problem when the plasma torches are used for metallurgical purposes is that for a given plasma impact velocity and plasma volume the amount of heat transmitted to the target is extremely small due to the low specific gravity of the materials used as the arcing gas.

During our studies we concluded on the one hand that the extent of the heat transfer effected by a plasma torch can be significantly increased if, besides the radiation heat transfer and the resistance heating of the target, the thermal energy, generated as described below, in the collision of the plasma ions with the target is also exploited. The positive ions of the plasma arc which are accelerated by an electromagnetic field impinge upon the surface of the target and/or of the melt pool thereof and enter deeper layers. During consecutive collision of positive ions with the atoms, ions and molecules of the target, the ions deliver their kinetic energy to said atoms, ions and molecules. As a consequence, the atoms and ions of the target get excited/ionized and the larger molecules of the target are torn into smaller parts. All this leads to an increase in the density of the excited infrared radiation within the target which results in an intensive raise of the target's temperature, due to which extreme temperature values of the target will be achieved. The larger the specific gravity of the material used as the arcing gas is, the higher the role of this so-called ‘collision heating’ is.

During our studies we concluded on the other hand that when a plasma arc treatment/exposure takes place, in every case there is a need for the occurrence of given chemicophysical reactions within the target, the start and the course of which reactions can be influenced in a planned manner by choosing appropriately the material of the arcing gas.

In the light of the above, the present invention aims at developing a novel plasma torch that eliminates the above described deficiencies and drawbacks of prior art's plasma torches and plasma furnaces (and other equipments) based thereon, and wherein the collision heating induced by the impact of the plasma phase arcing material's ions against the target is effectively exploited. A further object of the present invention is to ensure by means of the plasma torch concerned the activation and also the course of the planned chemicophysical processes and reactions of the target besides its heating. A yet further object of the present invention is to prevent the material used as the arcing material from increasing the amount of slag or waste, and to make it leave the reaction volume (eg. the plasma furnace) in the form of (a) byproduct(s) that is/are stable, can be easily processed and do(es) not load the environment. A yet further object of the present invention is to develop methods for the application of the novel plasma torch in some peculiar fields, eg. in the field of metallurgy or disposal of hazardous wastes.

Generally, the above objects are achieved by constructing a plasma torch, the arcing material of which comprises, instead of the traditionally applied non-metallic material(s), a gas/vapour that contains metallic atoms. Preferably, the gas/vapour of metallic atoms comprises alkali or alkali-earth metal vapour. Even more preferably, the gas/vapour that contains metallic atoms comprises sodium vapour (Na-vapour) or potassium vapour (K-vapour). The gas/vapour of metallic atoms optionally also comprises further chemical elements needed for the occurrence of the planned chemicophysical reactions of the target.

In particular, the above objects of the present invention are achieved in a first aspect by developing a plasma torch which comprises a plasma arc of an arcing material, wherein the plasma arc extends from a first electrode carrying high voltage to a second electrode being separated from the first electrode by a distance, and the arcing material is arranged within a storage means and is fed into the plasma arc through an outlet formed in the storage means, and wherein at least one collimator ensuring the convergence of the plasma arc is arranged along the plasma arc, and furthermore the arcing material is provided by a vapour of at least one metal.

In particular, the above objects of the present invention are achieved in a second aspect by a method for extracting pure metal from a metal-containing feedstock, wherein a smelter with a metal spout and at least one gas off-take and at least one feedstock inlet is provided, and wherein the feedstock is fed into the smelter through the feedstock inlet, and furthermore wherein
(a) a plasma torch is arranged within the smelter opposite to the feedstock, wherein the plasma torch has a plasma arc of an arcing material extending from a first electrode carrying high voltage to a second electrode, and wherein the arcing material is provided by a vapour of at least one metal;
(b) the plasma arc of the metal vapour is directed into the feedstock;
(c) the feedstock is heated with the plasma arc and the arcing material of the plasma arc, as a chemical reagent, is simultaneously brought into chemical reaction with the feedstock, wherein by means of the chemical reaction the metal content of the feedstock is freed, and at the same time the arcing material of the plasma arc is combined with the non-metallic constituents of the feedstock;
(d) the thus obtained substance containing the arcing material of the plasma arc is removed from the smelter through the gas off-take; and

the metal content freed is let out from the smelter through the metal spout as a pure metal.

In particular, the above objects of the present invention are achieved in a third aspect by a method for destructing an organic matter, wherein the organic matter to be destroyed is interacted with the plasma arc of a plasma torch, wherein a vapour of at least one metal is used to form the plasma arc of the plasma torch.

The most important advantages of the metal vapour arc plasma torches according to the present invention with respect to the traditional plasma torches of nonmetallic arcing gas are the followings:
(1) Due to the loosely bound valence electrons, the atoms of the arcing gases of appropriately chosen (essentially alkali or alkali-earth) metal vapour arc plasma torches can be more easily ionized with less energy input than the atoms/molecules of traditional nonmetallic arcing gases. Therefore, the ionization inducing portion of the energy applied to generate the plasma arc is less, that is, a larger fraction of the applied energy is used to accelerate the ions and hence for the collision heating of the target.
(2) The specific charge of the particles within a metal vapour plasma arc is much more uniform, since by a suitable choice of the arcing metal (which is essentially an alkali or an alkali-earth metal) it can be achieved that even at relatively high energy inputs only simply (or at most doubly) ionized metal ions be present in the plasma arc. Hence, from the point of view of ion composition, a more homogeneous plasma arc is obtained relative to the plasma arcs of traditional nonmetallic arcing gases. Therefore, the kinetic energy loss due to the collisions taking place between the individual components of the arc and the resulting energy efflux via electromagnetic waves (the radiation heating) is also less. Furthermore, the plasma arc can be better converged by the collimator which results in higher arc temperatures at the same level of energy input.
(3) The highly reactive positive ions of the appropriately chosen (essentially alkali or alkali-earth) metals, brought on to the target by the plasma arc itself, can be involved in chemicophysical (reductive) processes/reactions with the constituents of the target, that can be exploited eg. in metallurgy or in other fields of industry. Instead of the wastes and slags produced as a result of reactions by the application of nonmetallic arc plasma torches, industrially useful materials can be obtained, due to which the amount of waste and slag significantly decreases.
(4) Within traditional plasma torches (for economical reasons) preferably air or nitrogen is used as the arcing material. In such plasma torches at the arc temperature highly polluting NOₓ-type nitrous fumes build up. This kind of environmental damaging effect does not appear if a metal vapour arc plasma torch is used.
(5) The metal vapour arc plasma torches emitting intensive radiation in the ultra-violet (UV) region, eg. mercury-vapour arc torches, are exceptionally good for the disposal of hazardous organic materials, including the most deleterious biological infectious substances, as well as the most stable poison gases.

The invention will be explained in more detail with reference to the accompanied drawings, wherein

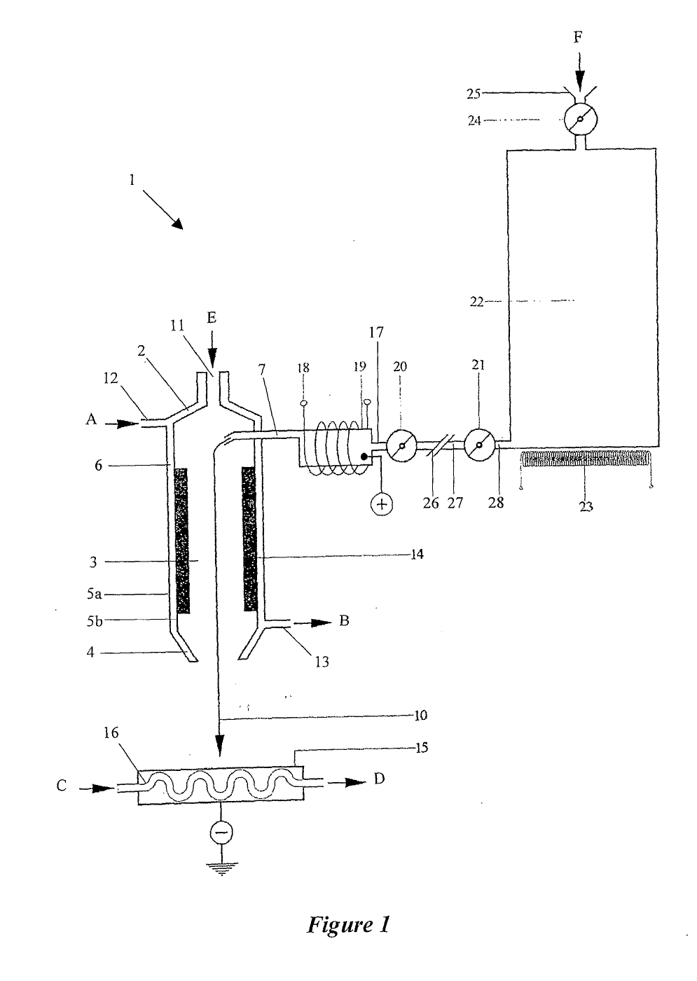

FIG. 1 shows a diagrammatic representation of a preferred embodiment of the metal vapour arc plasma torch according to the invention;

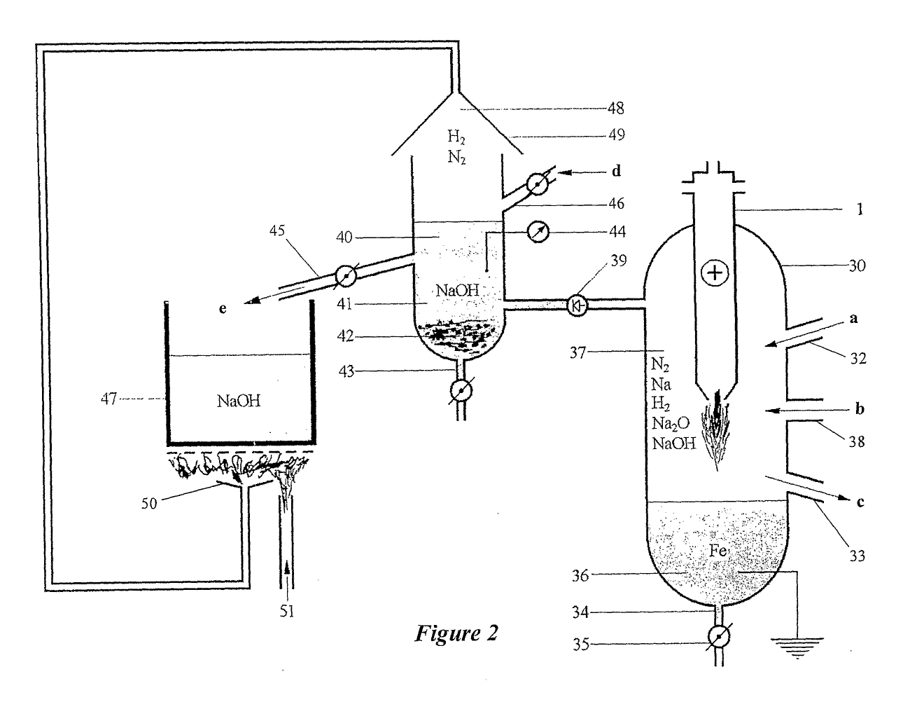

FIG. 2 schematically shows an assembly for implementing the reductive method according to the invention that is used to extract iron from iron oxide and iron hydroxide;

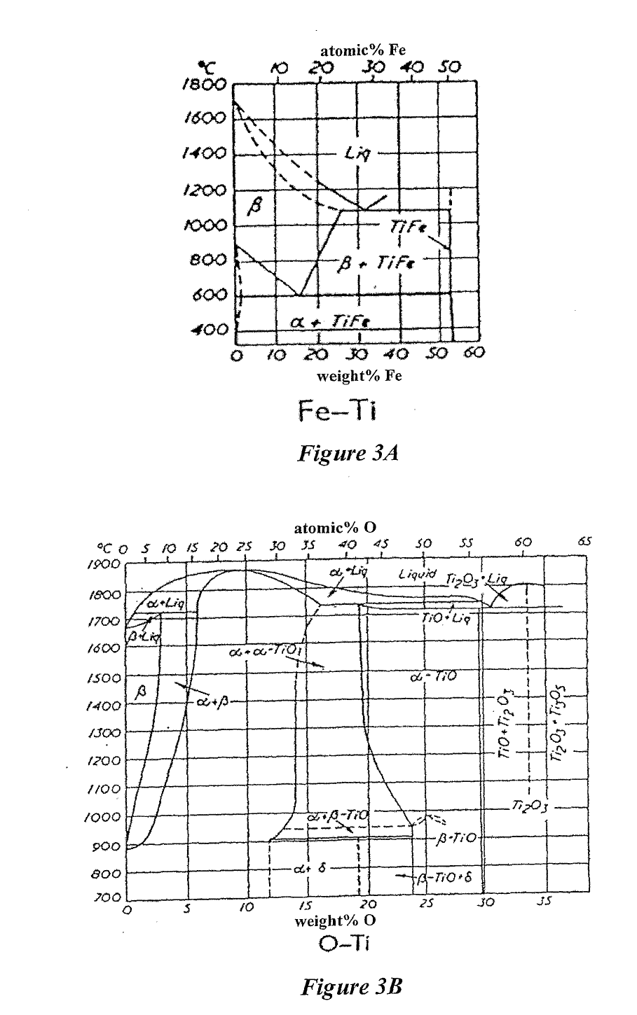

FIG. 3 shows equilibrium diagrams being of high importance in the field of titanium metallurgy;

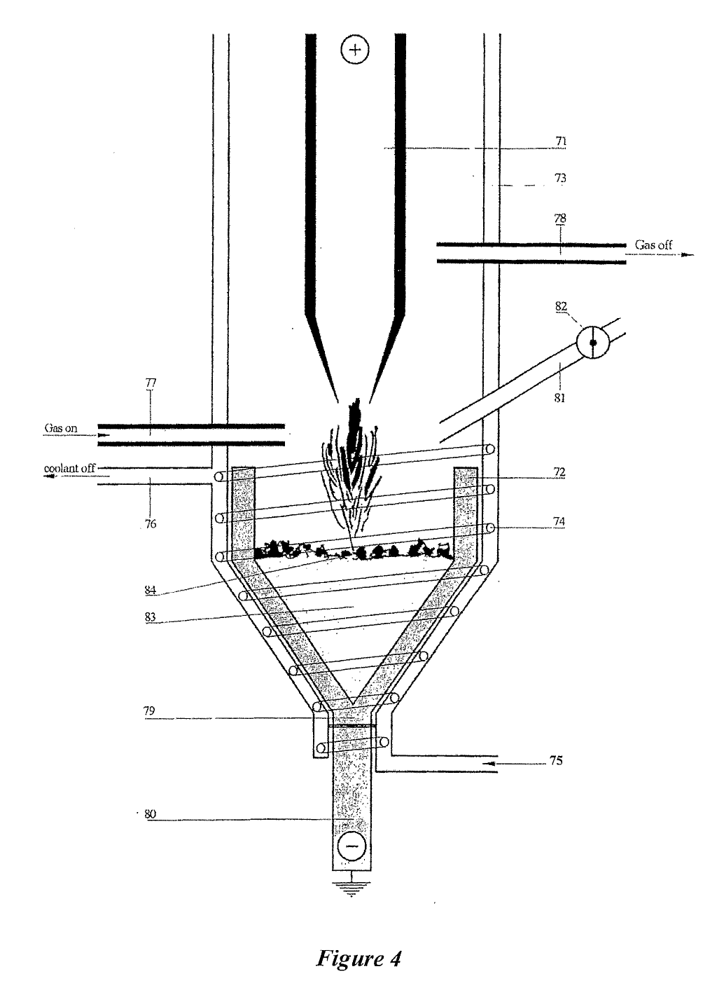

FIG. 4 schematically shows an assembly for implementing the reductive method according to the invention that is used to extract gold; and

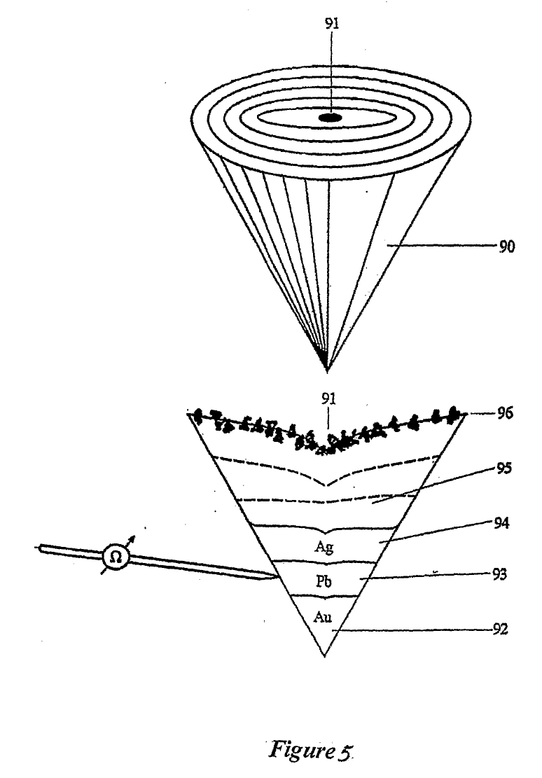

FIG. 5 shows perspective and longitudinal cross-sectional views of a metal ingot obtained by the assembly shown in FIG. 4.

FIG. 1 schematically shows a possible embodiment of the metal vapour arc plasma torch 1 according to the invention. The plasma torch 1 comprises an earthed cathode 15, a torch body 2, a carrier gas storing reservoir (not shown), a metal vapour generating reservoir 19 and a metal storing reservoir 22.

The torch body 2 is formed as a double-walled, longitudinally elongated, preferably annular body which encloses a plasma chamber 3. The torch body 2 terminates in a carrier gas inlet 11 at one end thereof, while a tip 4 closes it at its opposite end. The tip 4 is formed to insure a communication of the plasma chamber 3 with the outside of the torch body 2; the tip 4 is preferably formed into a shape of a conical frustum. The plasma chamber 3 extends from the carrier gas inlet 11 to the tip 4. The volume portion located between outer and inner walls 5a, 5b of the double-walled torch body 2 is filled with a coolant 6 which enters between the walls 5a, 5b through an inlet 12 (arrow “A”) and exits through an outlet 13 (arrow “B”). The coolant 6 is circulated within the torch body 2 preferably by means of a pump (not shown in FIG. 1) through one or more coolant reservoirs and heat exchangers. The torch body 2 is manufactured from a material with excellent thermal conductivity, as well as corrosion and pressure resistance; it is preferably made of stainless steel, while as the coolant 6 eg. distilled water or (due to its good thermal capacitance) ethylene glycol is used.

Within the plasma chamber 3 enclosed by the torch body 2 an electromagnetic collimator 14 is arranged coaxially with the torch body 2 and abutting against the inner wall 5b thereof. The collimator 14 extends along the length of the torch body 2. It serves to establish a plasma arc 10 by means of the magnetic field induced by it, and then to converge the obtained plasma arc 10 and to accelerate the ions thereof during the operation of the plasma torch 1. The construction and geometrical structure, as well as the operation of the collimator 14 correspond with that of the similar element(s) used in nonmetallic arc plasma torches known from literature, and hence are not discussed in detail. It should be noted, that in an embodiment of the collimator 14 used in the plasma torch 1 according to the invention, the cooling of the collimator 14 is indirectly performed by the coolant 6 flowing continuously within the torch body 2. However, other collimator geometries, that allow direct cooling of the collimator 14, can be also used, as it is known by a person skilled in the relevant art.

Referring now to FIG. 1, the cathode 15 forming the negative electrode in the shown embodiment of the plasma torch 1 according to the invention is arranged opposite to the tip 4 of the torch body 2 and is separated from that by a distance. The cathode 15 is preferably formed with a hollow interior and thus, as it is illustrated by the arrows “C” and “D” in FIG. 1, a coolant 16 can be circulated through it. The cathode 15 has a double function: on the one hand a target (not shown in FIG. 1) to be treated by the metal vapour plasma arc 10 is arranged on its surface, and on the other hand the plasma arc 10 gets closed through it. Besides the cathode's 15 capability of being cooled, a further advantage of the cathode design shown in FIG. 1 is that the direct cooling of the cathode 15, that is performed by the coolant 16 circulated through it, allows fine control of the course of the target's reactions. The coolant loop of the cathode 15 can be formed as part of the coolant loop of the torch body 2, however, it can be an independent loop, too. In further embodiments of the plasma torch 1 according to the invention, the target itself can play the role of the cathode 15. In such cases, however, in lack of the cathode 15, the fine control of the course of the chemical reaction(s) is impossible.

The cathode 15 can be of any shape, eg. a plate, a crucible, a ladle, etc. The cathode 15 should be made of a material resistive to the plasma torch 10 and having a good thermal conductivity. Such materials include eg. pure copper, composites of copper and tungsten and artificial coal. Furthermore, the cathode material should be chosen in such a way that neither physical nor chemical mixing and no intermixing by diffusion take place between that and the target, the arcing material of the plasma arc 10, and any intermediate or final products produced in the reaction of the target and the arcing material. As it will be discussed later in detail, whether or not this latter constraint is fulfilled depends on the material used actually as the target, the choice of the arcing metal and the planned reaction(s) between the material of target and the arcing metal.

The carrier gas inlet 11 of the plasma torch 2 is connected via a gas pump (not shown in FIG. 1) to a reservoir containing the carrier gas. As carrier gas an inert gas, preferably argon, krypton or other relatively hardly ionizable noble gas (i.e. having a high ionization potential) is used. The role of the carrier gas is to inhibit the hot metal vapour, that enters the plasma chamber 3 from the metal vapour generating reservoir 19, from condensing onto the inner wall 5b of the torch body 2 when the carrier gas is being blown through the carrier gas inlet 11 into the plasma chamber 3 by the gas pump.

The metal vapour generating reservoir 19 represents one of the essential components of the metal vapour arc plasma torch 1 of the invention. It stores the melt of a metal (or a material with a metal content) used for generating the plasma arc 10. Furthermore, the metallic melt pool contained within the metal vapour generating reservoir 19 also acts as the (consumable) positive electrode, i.e. the anode of the plasma torch 1.

The metal vapour generating reservoir 19 has a supply pipe 7 that penetrates through the walls 5a, 5b of the torch body 2 in a gas-proof manner into the plasma chamber 3 and terminates there in between the carrier gas inlet 11 and the collimator 14. The metal vapour generating reservoir 19 is equipped with a heater 18. The heater 18 serves to continuously boil the molten metal contained in the reservoir 19, and thereby to increase the pressure within the reservoir 19 to a value higher than the pressure within the plasma chamber 3 in order that the metal vapour created within the reservoir 19 be forced through the supply pipe 7 into the plasma chamber 3. As the molten metal acting as the anode carries high voltage relative to the earthed cathode 15, for safety reasons, the vapour generating reservoir 19 and the supply pipe 7 are made of an electrical insulating material, preferably eg. of a ceramics ensuring the heating of the molten metal. For similar reasons, the heater 18 is manufactured as a controllable induction heater. Other indirect heating mechanisms can be also used for boiling the melt within the vapour generating reservoir 19, the important thing is to insure electrical insulation of the molten metal carrying high voltage.

The outlet 28 of the metal storing reservoir 22 is connected to a melt inlet 17 of the vapour generating reservoir 19 through outflow controlling taps 20, 21, as well as a pump assembly 26 and a removable pipe 27 both installed between said taps 20, 21. The metal storing reservoir 22 can be (re)filled with the arcing metal (or material containing the metal) through a metal feed 25 closed by a tap 24. For keeping the material within the reservoir 22 in a state in which it can be easily pumped, the metal storing reservoir 22 is preferably provided with a heater 23. The heater 23 is an ordinary resistance heater, however, other means providing indirect heating can be also applied. For safety reasons, the melt inlet 17, the taps 20, 21, 24, parts of the pump assembly 26 that are in contact with the molten metal and the pipe 27, as well as the metal storing reservoir 22 itself (not considering that portion thereof which is used for effecting the resistance heating) and the metal feed 25 are also made of a ceramics with excellent electrical insulation properties.

In what follows, the operation of the plasma torch 1 according to the invention is discussed in brief.

When the taps 20, 21 are in their open positions, by actuating the pump assembly 26 the vapour generating reservoir 19 is filled through the pipe 27 and the melt inlet 17 with the metal kept in molten phase by means of the heater 23 within the metal storing reservoir 22. Then a high voltage is applied on the molten metal in the reservoir 19 relative to the cathode 15, and by switching the induction type heater 18 on, boiling of the molten metal is commenced. The pressure increase within the vapour generating reservoir 19 forces the vapour of the molten metal through the supply pipe 7 into the plasma chamber 3 of the torch body 2, wherein it is carried away by the carrier gas fed at high velocity (arrow “E”) through the inlet 11. The mixture of the inert carrier gas and the hot metal vapour enter the collimator 14, wherein the controlled high magnetic field excites the metal vapour into a plasma state, converges the thus formed plasma arc 10 and accelerates the positive metal ions thereof to a high velocity while urges them towards the tip 4 of the torch body 2. The obtained metal vapour plasma arc 10 passes through the tip 4, preferably impinges upon the target arranged on the cathode 15 and induces the target's (radiative, resistance, and collision) heating. At the same time, the metal ions carried by the plasma arc 10 commence the planned chemicophysical processes/reactions in the target and/or they themselves take place in the processes/reactions.

As the metal is continuously fed into the vapour generating reservoir 19 from the metal storing reservoir 22, said reservoir 22 becomes empty from time to time and hence has to be refilled. For safety reasons, during refill, the metal storing reservoir 22 should be electrically insulated. To achieve this, the taps 20, 21 are closed and after having made the perfectness of their closure certain, while—for the sake of safety—maintaining the taps 20, 21 closed, the ceramic pipe 27 bridging between said taps 20, 21 is removed. Then along with a simultaneous shielding gas pumping, the tap 24 of the metal storing reservoir 22 is opened and the reservoir 22 is filled with the proper metal (or metal containing material) through the metal feed 25 (arrow “F”).

After refill, at first the tap 24 is closed and then the pipe 27 is reinstalled placed into between the taps 20, 21. Having done the tightness and electrical conduction checks after the tap 21 had been opened, in case of satisfactory results, the tap 20 is opened and operation of the plasma torch 1 is carried on. It was found that in case the arcing metal of the plasma arc 10 had been properly chosen, for the refill of the metal storing reservoir 22 there is no need to interrupt the operation of the plasma torch 1—if the vapour generating reservoir 19 yet contains some arcing molten metal when the refill is started, a sufficent amount of energy is generated in the chemicophysical reactions taking place in the target for assuring self-sustainability of the reactions during the refill of the reservoir 22.

After having reviewed the general construction and operation of the metal arc plasma torch 1 according to the invention, its possible applications are considered. For this purpose, it is essential to analyse which metals are suitable for creating the plasma torch 1 in practice and/or on basis of what criteria the arcing metal or metal containing material is chosen.

In principle, any metal can be used as an arcing metal of the metal vapour arc plasma torch 1 according to the invention. As, however, it is also aimed that the target material be involved in reductive matter conversion process(es) with the metal ions of the plasma arc 10, and hence be transformed into industrially useful material(s) in a planned manner and with the generation of the least possible amount of waste and slag material, the metal to be used as the arcing material is chosen, in accordance with the matter conversion process(es) to be effected, by taking the following criteria into account:
within the planned reductive chemical process, the metal should react with the costituents of the target or at least one constituent thereof and should favourably influence the course of the reaction (eg. by means of heat generation), that is, the chosen metal should be the most electronegative among all the component metals of the target, which means that its normal chemical electrode potential should be the lowest within the system of the target and the plasma torch;
for being easily fed into the vapour generating reservoir 19, the metal should be easy to pump when it is in a molten phase, and its melting point should be low in order that it could be stored within the metal storing reservoir 22 and could be conveyed from there;
for being evaporated within the vapour generating reservoir 19, the metal should have a relatively low boiling point and a small heat of evaporation;
the metal should be easily ionizable, its ions should be stable, i.e. resistant against recombination, within the plasma arc 10 and only few ionization states thereof should appear even at relatively strong ionization effects (i.e. it should be mono- or bivalent, and when atomized, the levels filled should correspond to the electron configuration of a noble gas);
the metal should be relatively cheap, easily available and/or producable, and furthermore it could be stored in a simple manner; and
in its reactions with the target's constituents such products, serving preferably as feedstocks for industrial processes, should be generated that can be easily separated from each other.

Based on the above described criteria, the arcing material of the metal vapour arc plasma torch 1 according to the invention is chosen from the alkali metals, alkali-earth metals and mixtures, alloys and blends thereof. As the arcing material of the plasma torch 1 according to the invention, sodium (Na), potassium (K) and mixtures, alloys and blends thereof can be even more preferably applied.

In what follows, the industrial application of a metal vapour arc plasma torch 1 according to the present invention will be illustrated through some particular examples. In the examples, in accordance with the reductive processes to be effected, sodium (Na) is used as the arcing material of the metal vapour arc plasma torch 1 due to its favourable influences to the planned reactions.

### EXAMPLES

(1) Iron extraction from Ferrous and Ferric Oxides and/or from Iron Hydroxide.

In rolling, forging of iron and steel, and in general in hot forming of iron and steel accomplished without a protective atmosphere many million tons of iron scale build up that are basically composed of iron oxides and iron hydroxide. As the iron scale produced cannot be smelted, it is stored in huge, costly formed stockpiles instead of extracting the iron content thereof. By a method based on the application of a plasma torch according to the present invention, iron can be simply extracted from the iron scale being accumulated in such stockpiles.

For this, a sodium-vapour arc plasma torch is applied in particular within the assembly shown in FIG. 2, wherein the iron scale itself is the target to be treated by the plasma torch. The reductive reactions for extracting iron from iron-oxides and iron hydroxides can be essentially written in the following form:
2 Na+FeO [symbol] Fe+Na₂O
6 Na+Fe₂O₃ [symbol] 2 Fe+3 Na₂O
2 Na+Fe(OH)₂ [symbol] Fe+2 NaOH.

If the temperature within the target is set by the plasma torch higher than the sodium oxide's (Na2O) sublimation temperature, i.e. 1,275° C., after its creation, sodium oxide will sublime from the target and hence can be simply removed from the reaction chamber in the form of a sublimed gas. If this gas flows through a water-trap of cold water, sodium hydroxide is produced from sodium oxide in accordance with the reaction equation of
Na₂O+H₂O [symbol] 2 NaOH.
Here, sodium hydroxide is collected.

Generally, the iron scale considered also contains water (in a small amount). Hence, the reaction
2 Na+2 H₂O [symbol] 2 NaOH+H₂
also takes place in the target, wherein sodium hydroxide and hydrogen appears in the vapour portion of the reactor volume, just above the target, from where they can be simply blown down. The hydrogen gas from the water-trap can be vented into the atmosphere or under proper conditions it is burnt, and hence used for heat generation.

The sodium hydroxide collected is subjected to concentration, and then by evaporating it sodium hydroxide granulate is prepared which is a highly marketable chemical feedstock. This means that the arcing gas neither was converted into a slag material nor increases the amount of the waste gases to be cleaned, but instead it forms a byproduct which can be processed further.

FIG. 2 shows the reductive iron extraction process in detail. The extraction of iron takes place in an iron scale processing smelter 30 shown in FIG. 2, wherein a plasma torch 1, that uses sodium vapour as the arcing material, discussed earlier penetrates into the smelter 30 through its dome. The iron scale to be processed is fed into the smelter 30 through a mouth 32 (see arrow “a”). If addition of a slag-forming agent is required, the slag-forming agent, mixed with the iron scale, is also fed through the mouth 32. The slag formed exits the smelter 30 through a slag spout 33 cut into the wall of the smelter 30 (see arrow “c”). The extracted iron gathers in the bottom region of the smelter 30 in the form of an iron melt 36. The iron melt 36 is earthed, in this case it selves as the negative electrode of the plasma torch 1. The molten iron is periodically let out by opening a safety tap 35 preferably through a spout 34 formed at the very bottom of the smelter 30. The volume that is above the iron melt 36 within the smelter 30 is filled by a gas mixture 37 deriving from the plasma arc and the target, as well as created in the reactions thereof. The gas mixture 37 is basically comprised of sodium oxide and sodium hydroxide in accordance with the above. As in practice the amount of the reactants undergoing the chemical reaction cannot be exactly set, here the gas mixture 37 also contains some free sodium vapour coming from the arc of the plasma torch 1. Furthermore, said gas mixture 37 also contains some blow-off gas, preferably nitrogen, that enters the smelter 30 through a gas inlet 38 formed within the wall of the smelter 30 above the slag spout 33 (see arrow “b”). The blow-off nitrogen gas serves for pumping the gases/vapours forming the gas mixture 37 through a blow-off valve 39 into a water-trap 40 of cold water. The sodium vapour and the sodium oxide 41 converts into sodium-hydroxide within the water-trap 40, and the impurities drifted through the blow-off valve 39 with the gas mixture 37 precipitate as a slurry 42 at the bottom of the water-trap 40. The slurry 42 is removed from the water-trap 40 through a discharge pipe 43 equipped with a tap. The concentration of the caustic soda (sodium hydroxide) being produced in the water-trap 40 is continuously monitored by a pH meter 44, and when the concentration thereof has reached a value that is high enough, by opening a draw-off tap, the caustic soda is passed into an evaporating ladle 47 through a discharge pipe 45 (see arrow “e”). After a portion of the water-trap 40 has been discharged in this way, the water-trap 40 is replenished with cold water by opening the tap of a water inlet pipe 46 (see arrow “d”). In the meantime, the hydrogen and nitrogen contents 48 of the gas mixture 37 bubble through the solution of the sodium hydroxide 41 and exit into a suction-conveyor 49.

Among the gases in the suction-conveyor 49, nitrogen is an inert gas, while hydrogen, in the presence of oxygen, can be burnt into water by a burner 50. Since hydrogen and oxygen (being present in a proper ratio) might form explosive oxyhydrogen, the mixture of hydrogen and oxygen is burnt by the burner 50 after having mixed with natural gas. The obtained heat energy is used for the evaporation of the water content of the sodium hydroxide in the evaporating ladle 47. Consequently, dry sodium hydroxide remains in the ladle 47 which forms a chemical feedstock.

(2) Titanium Extraction from Titanium Containing Minerals.

Titanium is a silver-white, ductile metal, which is of great industrial importance. Its strength (that can be even further enhanced by alloying it) is comparable to that of annealed steels, however, its specific gravity is only about a half of the steel's specific gravity. Pure titanium has a very good corrosion resistance, its strength remains excellent even at high temperatures and it does not become brittle even at low temperatures—a feature which gives its distinctive industrial importance, especially in space research and aircraft industry.

The extraction of titanium from its most frequent minerals (rutile [TiO₂] and titanoferrite [FeTiO₃]) is, however, extremely complicated. The reason for this is that titanium is a chemical element having high tendency to form chemical compounds, it easily reacts with nonmetallic elements and forms alloys/solid solutions with other metals. However, titanium neither mixes nor forms a solid solution with sodium, potassium or aluminium.

As it is known by a person skilled in the relevant art, the traditional extraction of titanium from titanium ores and minerals consists of several consequent reductive steps, wherein the titanium is expelled from the titanium containing compounds by means of metals characterized by normal electrode potentials becoming more and more negative. Using preferably a sodium-vapour arc plasma torch 1 according to the invention, this multistep extraction process can be transformed into a single reaction, wherein the activation energy needed for the reaction is provided by the plasma arc colliding with the target of titanium mineral.

Titanium extraction is accomplished in an assembly similar to the one shown in FIG. 2, wherein the negative electrode of the plasma torch 1 is formed by an earthed cathode which is hollow and hence capable of being directly cooled and, furthermore, is arranged on the bottom of the smelter 30. (The cathode used here is identical in construction with the cathode 15 shown in FIG. 1.) The plasma torch 1 is formed with a geometry insuring the shooting of positively charged Na⁺ ions into the target with high intensity.

The reaction (deoxidation) that results in the pure crude titanium metal extracted from the target of the titanium mineral arranged on the cathode, as well as from its metallic compounds, undergoes in a pool of the target and of the molten metal located beneath the plasma torch 1. The beam of Na⁺ ions takes part in the deoxidation and in the separation with respect to molten metals of the titanium mineral target. For assuring continuity of the deoxidation taking place in the smelter 30, a sufficent amount of sodium is required. This is achieved by feeding liquid sodium through the mouth 32 or the gas inlet 38 into the smelter 30. The sodium fed into the smelter 30 in this way comes preferably eg. from the reservoir 22 which is presently filled with sodium, but other sodium sources can be also used for this purpose. Furthermore, to avoid the reaction of nitrogen with titanium, argon is fed into the smelter 30 through the gas inlet 38 as the blow-off and shielding gas instead of nitrogen.

The temperature of the molten metal pool is an extremely important technological parameter. The lowest and the largest temperature values being of importance in the field of titanium metallurgy can be read from the constitutional diagrams showing the equilibrium and quasi-equilibrium phases of titanium with important alloying elements, impurities and strong compound forming agents. These diagrams can be found in any textbook on metal physics (see eg. the book of “Metal Reference Book” by C. J. Smithells [published by Butterworths in 1962, London]), and hence are not discussed here in detail.

It is well known that in binary alloys neither alloying nor mixing takes place if the temperature exceeds the melting point of the constituent that has the highest melting point between the constituent metals—in such a case, the liquid constituents separate with respect to their specific gravities. This does not change until one of the constituents begins to boil and vapour phase also commences to play an important role.

For titanium metallurgy accomplished by a sodium-vapour arc plasma torch 1 according to the invention the two most important equilibrium diagrams are the iron-titanium and the titanium-oxygen binary alloy equilibrium diagrams shown in FIGS. 3A and 3B, respectively. From said figures it can be seen that the temperature of the melt pool should be at least 2,000° C. in order that titanium metal be in a molten phase and float on top of the melted iron in the smelter 30. Using a plasma torch of a well controlled power output, the titanium extraction process can be also effected at slightly lower temperatures of the target.

Furthermore, the exemplified method of titanium extraction can be quite easily automated. The titanium mineral (eg. titanoferrite) fed into the smelter 30 in a sufficent amount is heated to about 1,400° C. at a closed state of the smelter 30 in the presence of argon shielding gas, and the ratio of Na:Na₂O is continuously monitored by a proper analysing means arranged within the volume of the smelter 30. If the ratio remains approximately unchanged, the power of the plasma arc can be decreased; as a consequence of the reaction heat generated during the reaction induced by the Na⁺ ions, the set temperature value will not decrease. If, however, the ratio of Na:Na₂O raises (which indicates a decrease in the quantity of the metal oxide to be deoxidized by the Na⁺ ions), a control unit connected to the analysing means gradually increases the temperature in conformity with the ratio of Na:Na₂O stored as a function of time. The temperature is increased till the run-off temperature is reached—during the run-off period, the plasma torch 1 simply acts as a heater. If the temperature fell below the set value of 1,400° C. or the amount of the generated (sublimed) sodium oxide decreased, the plasma torch 1 should be activated again.

It should be noted that if titanium dioxide mixed into the gas mixture 37, it would precipitate as a slurry 42 in the water-trap 40 after having passed through the blow-off valve 39. After its removal, the slurry 42 can be fed into the smelter 30 through the mouth 32. The gas mixture 37 exiting the smelter 30 is processed in the same manner as discussed in Example (1). However, in the bottom region of the smelter 30, now the system of titanium melt floating on top of the iron melt appears under the argon atmosphere. The molten metals are overheated by the plasma torch 1 and after the slag has been discharged through the slag spout 33, a selective run-off is commenced, wherein care is taken of continuous operation of the gas inlet 38 and the blow-off valve 39 throughout the run-off. When the titanium is let out, particular attention should be paid to the protection of the titanium by a shielding atmosphere of argon from its exit from the smelter 30 to its cooling down.

(3) Copper Extraction from Chalcopyrite.

Copper (Cu) is a seminoble metal that can be found in nature also in its pure form. The most important copper ore is chalcopyrite (CuFeS₂), for the purposes of copper metallurgy and copper production in most cases this mineral is extracted. The extracted copper ore is enriched by a so-called flotation process.

To produce pure copper from chalcopyrite by a metal vapour arc plasma torch according to the invention, iron and sulphur should be removed. Copper reacts with neither nitrogen nor carbon dioxide. As the aim is to exploit both the iron and the sulphur contents of chalcopyrite, in the present case (besides noble gases) preferably nitrogen (N₂) should be used as the shielding gas. Since copper neither forms a compound with sodium nor mixes with it by diffusion, a sodium-vapour arc plasma torch is highly suitable for the processing of chalcopyrite. The latter statement is especially true in view of the fact that sodium forms neither a compound nor an alloy with iron. However, the situation is quite different in case of sulphur—sodium has an inclination to form compounds with sulphur and other sulphuric compounds in exothermic reactions, that is, sodium eg. reduces ferrous and ferric sulphides.

The first and at the same time a very problematic point of the traditional processing of the copper ore concentrate is that sulphur has to be removed from the concentrate. This is accomplished by means of a pyrites-calcining process which (depending on the valence of the copper) can be basically written in the form of the following oxidation process:
4 CuFeS₂+12 O₂=2 Cu₂O+2 Fe₂O₃+8 SO₂ or
4 CuFeS₂+13 O₂=4 CuO+2 Fe₂O₃+8 SO₂.
If this oxidation process is perfectly done, the metallic yield of the (copper oxide) reduction step following the pyrites-calcining step will be low. Therefore, the pyrites-calcining process is completed in several steps in traditional copper metallurgy.

In a first step, in the presence of a tiny excess of air the sulphur surplus of the fine ore containing CuFeS₂ chalcopyrite is calcined at a temperature of about 800° C. to 850° C., and then the obtained pyrites residues and the chalcopyrite broken into its sulphides are intermixed in sulphide melts in accordance with the following reaction:
CuFeS₂ [symbol] CuS+FeS (or Cu₂S+FeS).
As a consequence, a solution of metal sulphides is created. This intermediate metallurgical product is the so-called matte. After this, the second step of the oxidation process takes place, wherein the matte itself is oxidized into iron oxide and copper oxide. This step is accompanied by intensive formation of sulphur dioxide.

To avoid the takeoff of the copper compounds by the evanescent materials or slags and also a significant decrease in the metallic yield thereby, the process described by the above formula should be completed in several steps, at low temperatures and slowly.

In traditional metallurgy, crude copper is produced in various metallurgical melting plants, generally in converters, which is also a multistep process. In a first step, the FeS content of the matte is oxidized into FeO iron oxide (wherein sulphur dioxide is produced again). The obtained iron oxide is converted into slag, preferentially by adding a slag-forming agent of quartz-sand (SiO₂) thereto. In a second step, the copper sulphide remained in the converter is oxidized, melted under air, to such an extent that it could react with the remaining copper sulphide. Here, the reaction of
2 Cu₂O+Cu₂S=6 Cu+SO₂
takes place with a release of sulphur dioxide again.

The blister copper being on the bottom of the converter has a purity of 97-98%. Demands for copper of higher purities are fulfilled by cleaning, refining blister copper. As a first step, this comprises an oxidizing melting which is effected by exposing the surface of the molten metal rotated in a drum bath to an oxygen stream. High purity copper (electrolitic copper) is achieved by an electrolitic refining of the thus obtained remelted copper.

By using a sodium-vapour arc plasma torch according to the invention, the chalcopyrite based copper metallurgy is accomplished in the following manner.

As the chalcopyrite decomposes into sulphides at the temperature of 850° C. according to the reaction of
CuFeS₂ [symbol] CuS+FeS,
and as these sulphides do not even exist above the temperature of 1,600° C., because they are disintegrated into their constituents via thermodestruction, the traditional process can be carried out by the most simple plasmon energy gas-shielded pyrolytic process, even in a single step. At about 1,600° C., iron and copper are both in molten phase, but yet none of them boils and hence disturbs the separation with respect to specific gravity (moreover, iron and copper can be dissolved in each other only up to a limited extent, and since the operating temperature of 1,600° C. exceeds the melting points of both metals, neither intermixing by diffusion nor formation of an intermetallic phase is allowed). Furthermore, sulphur, which has a boiling point of 445° C., has already been evaporated, and it is in a hot vapour phase.

The specific gravities of iron and copper differ from each other up to an extent that is sufficent for the two metals to be separately and periodically let out. In the method according to the invention, the sulphur vapour led away is condensed in a closed volume as liver of sulphur, the crude iron is utilized and the crude copper metal has also been extracted. Thus, all components of chalcopyrite are utilized in the method described.

As discussed earlier, the most effective way to bring the molecules of the target into a really critical state is the bombardment thereof with the ions of the plasma, which requires an arc temperature that ranges from about 10,000° C. to about 25,000° C. This is an extremely high temperature for such a simple material as chalcopyrite, but on the one hand the volume of the arc emitted by the plasma torch can be decreased, and on the other hand the attention should be actually focused on the melt pool located below the torch. As it was concluded, in this location a temperature of 1,600° C. is enough. Since this temperature is required only for a short period of time, a further energy saving can be reached. Namely, in a first step the decomposition of chalcopyrite into sulphides is rapidly effected at a temperature between 850° C. and 1,200° C., and meanwhile ionized, plasma state sodium atoms, that are chemically more reactive than in general, are introduced into the chalcopyrite, wherein the sodium atoms rapidly deprive the sulphides of their sulphur atoms in accordance with the following equations:
CuS+2 Na═Cu+Na₂S
FeS+2 Na═Fe+Na₂S.

The Na₂S produced in this way is a highly hygroscopic compound that dissolves well in water and transforms into thiosulphate and sodium hydroxide in ambient air, that is
2 Na₂S+2 O₂+H₂O═Na₂S₂O₃+2 NaOH.

It is important to note that the electronegativity of sodium is larger than that of iron and copper, and hence the abstraction of sulphur from iron and copper sulphides results in a significant amount of heat generation. Therefore, if the process at issue is set up by the plasma, it becomes henceforth a thermodynamically self-sustained process.

The assembly for implementing the above process, apart from several tiny modifications, corresponds to the assembly shown in FIG. 2, and the plasma torch that can be applied is shown eg. in FIG. 1. Replenishment can be done as it was discussed in the chapter of “Titanium metallurgy” [Example (2)]. Furthermore, due to the intensive heat generating effect of the above sulphide-sodium reactions, the plasma torch 1 can be even switched off for the time period of this intervention.

In the smelter 30, the copper will be at the very bottom (which eases the selective run-off, moreover because of the high difference between the melting points, if the run-off temperature is continuously measured, the safety tap 35 can be even automatically closed at about 1,200° C., and then the crude iron becomes ready for letting out after reheating), the molten iron will float on top of the molten copper and is well-separated from it, and the smelter 30 is filled with sodium sulphide vapour above the molten iron.

The nitrogen atmosphere is introduced through the gas inlet 38, during run-off the inflow of nitrogen is maintained. The nitrogen gas will “blow off” the produced sodium sulphide from the smelter 30 through the blow-off valve 39. After the low-off valve 39, the sodium sulphide is fed into a quencher, wherein it is granulated or at least highly evaporated for further chemical processing.

Within the smelter 30 the cathode 15 of the plasma torch 1 sinks into the metallic copper melt of the refined material. Since in the present method neither mixing nor mutual interdiffusion takes place between copper and carbon, the cathode 15 is preferably made of artificial coal. To protect the cathode 15 and to ensure fine control over the process, preferably the hollow electrode of FIG. 1 is used as the cathode 15.

(4) Gold Extraction from Golden Ores and from Accumulated Pit-Heaps.

For humanity, gold—as it is known—has been of special importance for millenia; gold was maybe the first metal which attracted the attention of men. This might be related to its perfect resistance to oxidation and corrosion, to its rareness and shiny beauty, as well as to its good ductility. It is an extremely rare metal, the Earth crust's gold content is estimated to be about 0.005 ppm.

Gold is the noblest metal, a statement that is also true from the point of view of its normal electrode potential. Its melting point is 1,065° C., while its boiling point is 2,700° C. It is chemically and physically akin to copper and silver. In its compounds it can form easily decomposable tellurides and sulphides, wherein it has a valence of one or three.

The following technology is novel in the field of processing reef gold and its waste sludges, therefore in what follows, the processing of reef gold is considered in detail. Reef gold is obtained from its extracted ores and minerals which are sylvanite [Au, Ag, Te], krennerite [AuTe₂] and nagyagite [(PbAu)₂*(TeSbS₃)]. Calaverite [AuTe] is also an important and common mine ore.

In a first step, the gulfs of ore of the discovered reefs are enriched via flotation, which is a method for separating the useful component(s) of the ores. In most cases, the flotation agent is an oil that can stick to the metal portion of a grain and hence makes it hardly wettable, i.e. hydrophobic. (As a consequence, a grain containing no metal on its surface is highly wettable.) Then, a frothy material is mixed into the suspension and generally air bubbles are blown in from below. The air bubbles stick to the oily (metallic) grains and raise them into the froth, while all the other grains stay on the bottom of the water. By collecting the froth, the metal containing portion of the sludge is obtained, while further portions thereof are thrown to a pit-heap.

The floatated gold flour is processed further via amalgamation; thus the amalgamation is a method for extracting virgin gold. Amalgamation is a method that severely damages the environment. In amalgamation one exploits that the auriferous grains stick on to a copper plate coated with mercury and form amalgam with the mercury on the plate by time. The various non-auriferous metals yet being present in the ore (including also tellurium) and the sulphides thereof, as well as the oily impurity residuals of the flotation impair both the sticking of gold into mercury and the contact of gold with mercury, therefore after a certain amount of time the grains stuck onto the plate are removed by a rubber scraper and via dilution with about five to six times more mercury are washed over. Then the mercury is filtered out from the thus obtained mercury-amalgam mixture through an amalgam press (some time before deerskin leather was used for this purpose), and the mercury content of the amalgam is evaporated (by heating it above the temperature of 357° C.). The residue will be the virgin gold that should be further purified by other methods, while the further portions are also thrown to the pit-heap.

The cyanide leaching technology is used either for processing the flotated gold flour concentrate or as a continuation of the amalgamation, for the extraction of the gold content of the residual sludge after the amalgamation. The gold is extracted, leached from the auriferous fine ore in both cases by a sodium cyanide (NaCN) solution in the presence of oxygen of the ambient air. In general, the coarse-grained smalls is leached for 3-4 weeks by an 0.5% (by weight) NaCN solution, the fine-grained smalls is leached for 3-4 days by an 0.25% (by weight) NaCN solution, while the sludge containing the fmest grains is leached for 3-18 hours by an 0.1% (by weight) NaCN solution. In this process the reaction of
4 Au+8 NaCN+2 H₂O+O₂=4 Na[Au(CN)₂]+4 NaOH
takes place. Then the complex golden salt is reduced by zinc according to the following reaction:
2 Na[Au(CN)₂]+Zn═Na₂[Zn(CH)₄]+2 Au.
After a washing-out and a drying, a sulphuric acid zinc removal step is effected, then the gold that is washed and dried again is melted in a graphite crucible.

Before a technological planning would be commenced to carry out a gold extraction process by means of the metal vapour arc plasma torch according to the invention, in lack of a factual chemical analysis of the material to be treated by the plasma arc (i.e. the target of the plasma torch), it is worth surveying the major constituents thereof and also some properties of the constituents. The material to be treated comprises:

first of all, the constituents of the mineral ores themselves:

| | | specific | melting | boiling | |
|---|---|---|---|---|---|
| | | gravity | point | point | resistivity |
| material | | (g/cm³) | (° C.) | (° C.) | (Ω · cm) |
| gold | Au | 19.3 | 1,063 | 2,970 | 2.3 |
| silver | Ag | 10.5 | 961 | 2,210 | 1.6 |
| tellurium | Te | 6.24 | 450 | 990 | 4.36 · 10⁵ |
| tin | Sn | 7.30 | 232 | 2,270 | 12.8 |
| lead | Pb | 11.4 | 327 | 1,725 | 20.6 |
| antimony | Sb | 6.62 | 631 | 1,380 | 420 |
| sulphur | S | 2.07 | 119 | 444 | 2 · 10²³ |

sulphide minerals (from geological layers) and their companion metals:

| | | | | | |
|---|---|---|---|---|---|
| copper | Cu | 8.96 | 1,083 | 2,595 | 1.7 |
| zinc | Zn | 7.14 | 420 | 906 | 6.0 |

constituents due to amalgamation within the sludge processing:

| | | | | | |
|---|---|---|---|---|---|
| mercury | Hg | 13.6 | −38.4 | 357 | 95.8 |

possible accompanying silicate rock residues (only an estimation):

| | | | |
|---|---|---|---|
| quartz | SiO₂ | 1.98 | 1,420 |
| corundum | Al₂O₃ | 3.85 | 2,050 |

From the above composition analysis in the tabular form, it can be seen that separation of the individual constituents is an extremely complicated task. Hence, the aims of the primary technological process are the followings:
each of the metals/semimetals of Au, Ag and Te should be extracted;
the heavy metals that pollutes live waters and the above listed non-ferrous metals should be isolated either separately or as alloys;
the remaining slag material should be vitrified to create a water-insoluble substance therefrom; and
the above should be achieved by a closed-loop, environment-friendly technology that is suitable for both reforming the daily production in accordance with the above requirements and processing of the dead material reservoirs implying the potential of environmental catastrophes.

It is worth noting that not only the noble metals, i.e. gold and silver are aimed to be extracted in the present case, but also the semimetal tellurium, because it is a rarer and more useful element than gold, and moreover the tellurium “production” of several hundreds, or maybe a thousand years is present in the slurry reservoirs. The alloy of tellurium with bismuth, i.e. the Bi₂Te₃ alloy, is an ill-famed semiconductor. Tellurium is a peculiar p-type semiconductor by means of which the electric and thermal energies can be reversibly converted into each other.

Returning to the aims listed, besides the variety of possible targets and their diverse properties (specific gravity, melting point, boiling point) discussed above, the intermixing of tellurium with sulphur, selenium, tin, lead and bismuth, as well as with alkali and alkali earth metals, and aluminium makes the situation more complicated. For this, it is a little remedy that tellurium refinement is an elaborated chemical and physical technology (it is actually a series of multiple chemical purifications, extractions and purifying distillations), and hence, if a tellurium concentrate could be provided and passed to the proper laboratories, the metallurgical subprocess would be considered to be successful.

It is a further remedy that tellurium does not dissolve in water, but dissolves well in bases. The same also holds in case of alkali tellurides, and hence in case of sodium telluride, too (although alkali tellurides also dissolve in water). It is also interesting to note that tellurium transforms into a gas above its boiling point and exists as molecular tellurium (i.e. as Te₂) up to the temperature of 2,000° C.

If the equilibrium constitutional diagrams of tellurium are looked at, the double nature of tellurium can be easily seen, i.e. it can behave as both a metallic and a nonmetallic element. In the latter case the Te—Zn compound is the most stable, it decomposes only at the temperature of 1,239° C. (some further binary intermetallides or compounds and their decomposition temperatures are also given here: Au—Te 1,063° C.; Ag—Te 960° C.; Sn—Te 790° C.; Pb—Te 906° C.; Sb—Te 630° C.; S—Te 453° C.; Cu—Te 1,033° C.; Na—Te [in the form of Na₂Te] 953° C.). In conclusion: above the temperature of 1,250° C., various tellurium compounds decompose, elemental Te segregates from them, that is, the compounds and solid solutions of tellurium experience a thermodegradation leading to the segregation of elemental tellurium; in the temperature range of eg. 1,250-2,000° C. only Te₂ molecules exist.

Furthermore, it should be also taken into consideration that an intensive evaporation of a substance, i.e. its transition into a gaseous phase, can be expected (and an attention should be also paid thereto) if its actual temperature (under the given circumstances) exceeds its boiling point.

Briefly summarized: the operating temperature of the metallurgical subprocess to be accomplished is preferably chosen within the temperature range of 1,300-1,350° C., which from a technological point of view is an easily maintainable, measurable and controllable range within a tolerance of ±30° C. At these temperatures most of the metallic constituents, namely Ag, Au, Sn, Pb and Cu get molten and arrange within the melt with respect to specific gravity. This especially holds for silver and gold, as they are noble metals, which do not combine diffusively at these temperatures with lead being present between them. Further sulphide metals, such as the tin, antimony, copper and possibly also a significant portion of the lead might alloy to a smaller or larger extent (as the differences in the specific gravities are very small), especially if the cooling of the melt (i.e. the quenching) is not rapid enough, although their binary equilibrium constitutional diagrams do not suggest this behaviour.

In the present case, preferably a sodium-vapour arc plasma torch is used, because—as it was discussed earlier (see eg. Example (3) describing copper metallurgy)—on the one hand it binds the evanescent sulphuric vapours in the form of sodium sulphide, and as it is known, this gas can be blown off by an inert (or shielding) gas applied in the assembly for implementing the process. On the other hand, the electronegativity of sodium is much lower than that of zinc, therefore the more electronegative sodium (if present in a sufficent amount) does not allow the combination of zinc with sulphur. Moreover, sodium also extrudes zinc from its random compounds, especially if sodium is present in the form of sodium ions (Na⁺) coming from the plasma arc. This also holds for the oxygen having entered the assembly by accident (eg. from the wet flotated fine ore, the air filling the space among the grains of the fine ore, etc.). Hence, the actually undesirable zinc leaves the assembly as vapour through blow-off, or might partially be incorporated into the alloys of akin heavy metals (deriving from sulphides), as discussed above.

The metallic zinc begins to dissolve in water above the temperature of 70° C., and in bases above the pH value of 12.5, otherwise these solvents cannot solve it. (Luckily, zinc hydroxide [Zn(OH)₂] does not dissolve in water and it dissolves in bases only above the temperature of 39° C., when it decomposes into ZnO zinc oxide and water. However, zinc oxide is soluble in neither water nor sodium hydroxide.)

A significant mercury pollution can be also expected, chiefly when a substance from a slurry reservoir got to there as a waste material of amalgamation is processed or subjected to an environmental disposal. From a technological point of view this is not problematic, since—as it is known—mercury compounds disintegrate at the boiling temperature (357° C.) of mercury, and then the mercury goes into a vapour phase. Thus, the mercury vapour is simply blown off the assembly at the operating temperatures of 1,300-1,350° C. of the metallurgical process according to the invention. Furthermore, as the mercury vapour cools in a quenching tank below 357° C., only ordinary mercury beads will appear and be taken into account within the slurry 42 of the aqueous-alkali water-trap 40 arranged in the quenching tank (see FIG. 2).

The condensed zinc can be found also here, and it can form an amalgam with the mercury which is present in higher amounts. From technical point of view, this might ease the discharge of the slurry 42 but it is of no particular importance anyway. An essential technological parameter for separating the vapour-phase components discussed earlier and appearing in the assembly is that the temperature of the water-trap 40 within the tank should be about 20° C., preferably 10-50° C., but in no way exceed 60° C. Furthermore, the alkalinity (pH value) of the water-trap 40 within the tank should be lower than is pH 11, but in no way reach pH 12. These parameters can be measured by the pH meter 44 (see FIG. 2) and a thermometer also arranged within the tank, and controlled automatically via actuating the tap of the inlet pipe 46 with respect to the measured values. Furthermore, the tank containing the water-trap 40 can be also equipped with a separate cooler controlled by the thermometer. Preferably, the level of the slurry 42 is also monitored by a simple level indicator, the measured values of which can be used to control the tap of the discharge pipe 43.

Luckily, mercury forms compounds with tellurium only if the tellurium content is higher than about 35-38% (by weight). Hence, the whole amount of tellurium, as dissolved or in the form of sodium telluride, as well as of sodium sulphide is within the aqueous solution of sodium hydroxide discharged into the evaporating ladle 47. After evaporation (and possibly also applying a centrifugal separation technique), the tellurium becomes chemically and/or electrochemically extractable from this solution (the normal electrode potentials of the elements at issue [Na⁺: −2.71 V; Te²⁻: −0.91 V; S²⁻: −0.51 V] also suggest this).

Some silicate minerals coming from the process of ore enrichment and/or bound to metallic grains can be also present. The composition of each of the accompanying rocks is not known, but it can be well approximated by quartz (SiO₂) and corundum (Al₂O₃), the grains of which are extremely stable and heat-resistant, as it was shown earlier. Furthermore, these grains have high melting points, but their specific gravities are relatively low. Hence, these substances will float on top of the molten metal as slag.

To avoid accidental formation of impurities and undesirable compounds in the rare and expensive substances to be extracted, argon (Ar) is used for the shielding gas. The counter-electrode, i.e. the cathode, is made of artificial coal, since the elements aimed to be extracted do not combine with carbon under the circumstances described. In principle, the plasma torch corresponds to the one shown in FIG. 1, however, several important modifications have to be made in the implementation of the metallurgical subprocess. Accordingly, the basic construction of the plasma torch 1 shown in FIG. 1 is left unchanged, but the geometry of the cathode made of artificial coal is changed and instead of run-off, a quenching of the molten metal will be effected on the basis of the following points:
since the relatively small amount of gold cannot be separated in a cheap manner from the other materials being present in significantly higher amounts reliably and without loss, a selective run-off cannot be applied;
if the molten metal being separated with respect to the specific gravities of the individual constituents was quenched in a cylindrical crucible, the gold would separate in the form of a very thin disk on the bottom of a cylindrical body; due to the fineness of the disk, however, it would be problematic to remove the disk from the body—even a tiny error during the quenching (i.e. quenching takes place slower than as required) results in a disk thickness that is comparable to that of the interdiffused layer (solid solutions of metals; Pb, Ag, etc.).

Based on the above, a quenching method using a conical, funnelled cathode made of artificial coal is chosen, as it is shown in FIG. 4. Therefore, the metals to be extracted—basically gold—will be concentrated in a cone, while the rest of the metals which have lower and lower specific gravities, are present in larger and larger amounts but are less and less precious will occupy more and more space within the closed funnelled cathode made of artificial coal.

The cathode is made of artificial coal, because it has a good thermal conductivity and combines in no way with the metals to be extracted. Furthermore, it is cheap and can be fabricated to the shape required.

Referring now to FIG. 4, a sodium-vapour arc plasma smelter containing a hollow conical cathode made of artificial coal is set up as follows. As it is illustrated in FIG. 4, a sodium-vapour arc plasma torch 71 (shown in FIG. 1) is directed to a cathode 72 made of artificial coal. The closed, funnelled cathode 72 is provided with a cylindrical edge, because during melting, the enriched ore, that has a much lower space filling, fed into the smelter shrinks, fuses, and hence its volume gets smaller; however, a conical metal ingot is aimed to be achieved by the metallurgical operation. Therefore, the content of the cylindrical portion (more or less) also melts and shrinks into the cone; from the technological point of view this is indifferent, especially as a slag layer will be situated on the top. The fragile cathode 72 is held by the wall 73 of the smelter, the geometry of the artificial coal cone perfectly fits into the smelter.

A cooling coil 74 is arranged within the smelter's wall abutting with the cathode, by means of which a coolant 75 can accomplish an extremely rapid cooling (quenching). Quenching is switched on when the melting process has been completed, no more gas is released from the target and all the gases within the (smelter) assembly have already been blown off by the shielding gas of argon. The argon gas fed through a shielding gas inlet 77 and the vapours generated in the assembly exit through an outlet 78. If a suitable, expediently fabricated gas analysator means is connected to the outlet 78, the progress of the metallurgical process can be traced via the composition (or other characteristics) of the gas, and hence the end of the process (when the plasma torch is switched off, and the quenching coolant is started) can be also detected.

During quenching which lasts till cooling down to the ambient temperature, the circulation of the shielding gas is continuously maintained and it is switched off when the cooled state has already been reached. The outlet 78 is connected through the blow-off valve 39 shown in FIG. 2 to the assembly illustrated in FIG. 2. The funnelled electrode made of artificial coal terminates in a block 79 also made of artificial coal, wherein the block 79 bears on an earthed cathode 80 made of artificial coal. There is a perfect electrical contact between the block 79 and the cathode 80. The cathode 80 forms a built-in part of the plasma smelter assembly, while the funnelled cathode 72 can be removed with the metal, and it is highly probable that it should be replaced by another one (a new piece) before the next run-off. The smelter can be filled with the mineral concentrate through a feeding inlet 81 either continuously with small batches or via a single filling. In the latter case the assembly can be closed by a tap 82, which is preferably formed to be capable of automatic opening in case of overpressure. Through the feeding inlet 81, it is also possible to influence the melting process during the operation by adding various auxiliary products.

After completion of the melting process, a molten metal 83 ordered with respect to specific gravity remains back inside the funnelled electrode, wherein a slag 84 of silicon and aluminium oxides floats on top of the molten metal 83. After quenching of the melt and removing the cathode that forms a casting mould, a conical ingot 90 shown in FIG. 5 is obtained. The ingot 90 removed from the casting mould is almost of a perfect cone, in harmony with the shape of the casting mould formed by the cathode, however, due to the heat shrinkage, a slight dip 91 occurs in the circular base of the cone.

As it was discussed earlier, the metals of the mineral concentrate are ordered with respect to their specific gravities and frozen in the cone: gold 92 being the heaviest or having the largest specific gravity is situated on the very bottom, then comes lead 93 packed between gold 92 and silver 94, and further metals 95 (sulphide mineral non-ferrous metals) stratify above silver 94. It is of great importance that said metals are significantly separated from each other, the gold is in the form of the gold cone at the very bottom, and the conical frustums of the metals being deposited in layers are situated just above this in a geometrical arrangement of cylindrical symmetry. Therefore, if it is known where the interfaces are located between these conical frustums, the various metals can be even mechanically divided. Now the locations of the interfaces between the adjoining metals are known, because the resistivities of the metals differ specifically from each other. By mapping the conical ingot 90 shown in FIG. 5 with a resistance-measuring probe 97, the boundaries between various metals can be unambiguously detected—the (mechanical) slicing should be carried out just at these locations.

The further way of gold and silver is clear: they are delivered for refining or casting bricks stored in banks thereafter. Further non-ferrous metals 95, including the disk of lead 93 excised from between gold and silver, are separately transferred to the chemical industry or to the plants specialized for non-ferrous metallurgy. If further metal extraction is feasible, the slag 96 that might also contain important non-ferrous metals should be remelted alone, as a slag heap. If further metal extraction is unfeasible, which is the situation in most cases, the slag 96 goes through a final vitrification (possibly accompanied by the addition of slag-forming agents thereto) and thus is transformed into glassy rock that can be used for landfill or for other purposes as an inert substance.

It is also worth noticing that the conical electrode structure distorted the electrostatic field of the plasma shown in FIG. 1, i.e. the flux-lines of the electric field in such a way that the so-called point effect facilitated the accomplishment of higher gold and silver yields. It should be also noted that the method detailed above corresponds with a galvanic sludge waste processing.

(5) Thermodestruction of Organic Materials.

Depending on the age and on literature, the term “organic material” has a different content. Formerly, only the organic, carbonous compounds of living organisms were related to this term, nowadays in most cases all carbonous compounds are referred to by this term. In other places this term refers to the latter content, excluding metal carbides and carbon dioxide, etc. As a consequence, denomination and/or defining the compounds concerned is also a difficult task, hence to illustrate the usability of plasmon energy processes in this field, several thermodestructive methods are exemplified here.

Carbon atoms easily form covalent bonds with each other. This allows such variants of stable compounds, that nowadays chemists already have a knowledge of several ten times as much carbon compounds as the total number of the known other compounds. A great deal of these compounds does not even occur freely in nature.

This great set of compounds is classified from other aspects.

Here, the metal-carbon compounds are not dealt with as their transformations and/or other treatments by plasmon energy can be originated from metallurgical processes analogous with the application examples described previously.

According to a further classification aspect, the open-chain (aliphatic or acyclic) carbon compounds and the cyclical (alicyclic) carbon compounds that can be derived from benzene, i.e. from a “benzene ring” are of great importance. Among the aliphatic compounds there is a lot of hardly decomposing and hence from the point of view of environmental protection damaging plastic materials, a good few type of which can be treated in traditional combustion plants with difficulties, but poison gas compounds can be also found in this group of compounds. The total number of alicyclic hydrocarbons is about several hundred thousands, quite a few artificially produced variants thereof proved to be a pesticide or a fungicide, but later it came out that they are strong poisons and cause cancerous changes in human beings, as well as induce genetic damages, even for several generations.

Last but not least there are also organic compounds, and living organisms themselves. Messages speak about viruses and bacteria on the Earth having more and more mutants that become increasingly resistant, let it be the Ebola virus, the HIV virus, viral encephalitis, virus pneumonitis, etc. or simply a bacteriological weapon.

Besides the destruction of biological weapons, there are two major fields, wherein the biological disposal by plasmon energy can be applied:
the disposal of hazardous hospital wastes; and
the destruction of airport wastes before the entry system.

In these days, smaller combustion plants are operated in the more modern airports, wherein the destruction of airport wastes (food, cutlery, municipal waste, sewer waste, etc.) take place in the international zone. Similarly, in most countries the hazardous hospital wastes are to be incinerated separately.

It is thought that a slightly modified, pragmatical, modular thermodestructive and vitrification technologies accomplished by a metal vapour arc plasma torch according to the invention which cause all-out bioactive molecule destruction provide excellent—although overassured—means for solving the above problems (however, this forms only a single, nevertheless an important segment of a set of problems).

It has been previously observed that an ultraviolet (UV) light falling into a wavelength range extending from 10 nm to 400 nm has extremely strong biological effects. The atmosphere filters out a great portion of the UV region from the spectrum of the sunshine, anyway it could be dangerous even to humans, as eg. exorbitant sun-bathing, especially its UV portion, induces the formation of cancroid. An UV radiation of high intensity having a wavelength about 300 nm has an antiseptic, bactericide effect in such an extent that it is also used for purifying biologically polluted waters.

The essential thing is that it was clearly shown that upon exposure to an UV radiation with a wavelength of at most 300 nm (i.e. being within the range of 10-300 nm), photodestruction of nucleic acids also takes place, and hence the UV radiation destroys just the basic building blocks of the undesired viruses, bacteria and bioactive substances via photodestruction.

Based on the above, it is absolutely sure that the electromagnetic radiation spectrum of a sodium-vapour arc plasma torch, which operates properly at high degree of ionization, is also a continuous spectrum characteristic of a black-body radiation and also contains the “required” ultraviolet spectrum in a sufficent amount or density (W/mm²). Nevertheless, as the spread-out of a virus can cause an excessively huge tragedy, it is better to apply excessive security measures. Hence, mercury vapour is mixed into the vapour of the sodium-vapour arc plasma torch illustrated in FIG. 1 in an amount of 10-20% (by weight). Mercury will be hardly ionized, and its ionization is at least more difficult then that of sodium as its ionization potential is much higher. On the contrary, mercury is an “ill-famed” UV radiant, eg. in mercury vapour lamps. When light sources are used, light powders should be applied on lamp bulbs, which light powders converts the UV rays into the visible region. In this way, the “black-body” spectrum is slightly distorted by the addition of mercury in the amount of 10-20% (by weight): the amount of the radiation within the UV region of 10-400 nm will increase to a value higher than in general.

Furthermore, biodestruction is accompanied by thermodestruction, which is ensured on the one hand by the working temperature of the plasma and on the other hand by the hardly ionizing mercury having large atomic mass and being also present in the plasma arc. As in most cases the carbonous organic compounds are covalent-bond compounds, thermodestruction is a characteristic and important component of the influence of the plasma torch. Naturally, the ionic and kinetic effects of the plasma beam will remain unchanged.

The assembly for the disposal of biological hazardous wastes can be easily built from modules that are already available. The plasma torch itself is the sodium-vapour arc plasma torch 1 shown in FIG. 1 with a W—Cu cathode. Here the only difference is that a further mercury-storing reservoir is connected, in the same way as the metal storing reservoir 22, into the metal vapour generating reservoir 19 equipped with induction heating. The thus obtained metal vapour arc plasma torch according to the invention is connected with a traditional PEPS (Plasmon Energy Pyrolysis System; registered trademark of Vanguard Research Co.) assembly, that can also accomplish vitrification by means of auxiliary products, and the plasma torch thereof is replaced by a sodium-mercury vapour arc plasma torch.

The only difference between this assembly and the traditional PEPS assembly is that mercury is recovered from the slurry of the quenching sodium hydroxide tank of the PEPS assembly and then is recirculated into the assembly, while the sodium vapour blown in by the plasma torch can be recycled as sodium hydroxide in the quenching column of the PEPS assembly—the sodium hydroxide being present in excess can be led out, i.e. extracted for recycling.

1-23. (canceled)

24. A plasma torch comprising a plasma arc of an arcing material, wherein the plasma arc extends from a first electrode carrying high voltage to a second electrode being separated from the first electrode by a distance, and the arcing material is arranged within a storage means and is fed into the plasma arc through an outlet formed in the storage means, and wherein at least one collimator establishing the plasma arc and ensuring its convergence is arranged along the plasma arc, characterized in that the arcing material is provided by a vapour of at least one metal or metallic compound.

25. The plasma torch of claim 24, characterized in that the at least one metal is chosen from the alkali metals, alkali-earth metals or mixtures or compounds thereof.

26. The plasma torch of claim 24, characterized in that the at least one metal or the at least one metallic component of the metallic compound is sodium (Na) or potassium (K) or a mixture thereof.

27. The plasma torch according to claim 24, characterized in that the arcing material is stored in molten phase within the storage means, and that the storage means is equipped with a unit capable of converting the molten arcing material into vapour.

28. The plasma torch of claim 27, characterized in that the unit capable of converting the molten arcing material into vapour is a heater (18).

29. The plasma torch according to claim 24, characterized in that the arcing material is itself the first electrode.

30. The plasma torch according to claim 24, characterized in that the second electrode is earthed.

31. The plasma torch according to claim 24, characterized in that the plasma arc (10) is at least partially surrounded by a torch body (2) which equally enables the plasma arc's (10) entry into and exit from the torch body (2).

32. The plasma torch of claim 31, characterized in that the torch body (2) is formed as a double-walled element comprising outer and inner walls (5a, 5b), wherein a coolant (6) is present between the outer and the inner walls (5a, 5b).

33. The plasma torch of claim 31, characterized in that the collimator (14) is arranged in its full extent within the torch body (2) and abuts with its inner wall (5b).

34. The plasma torch according to claim 31, characterized in that the second electrode is arranged outside of the torch body (2).

35. The plasma torch according to claim 24, characterized in that the second electrode is formed as a hollow electrode.

36. The plasma torch according to claim 24, characterized in that the arcing material has a component which emits intensive ultraviolet radiation during its conversion upon excitation.

37. The plasma torch of claim 36, characterized in that the component emitting intensive ultraviolet radiation is a mercury containing substance.

38. A method for extracting pure metal from a metal-containing feedstock, wherein a smelter with a metal spout and at least one gas off-take and at least one feedstock inlet is provided, and wherein the feedstock is fed into the smelter through the feedstock inlet, characterized in that
(a) a plasma torch is arranged within the smelter opposite to the feedstock, wherein the plasma torch has a plasma arc of an arcing material extending from a first electrode carrying high voltage to a second electrode, and wherein the arcing material is provided by a vapour of at least one metal;
(b) the plasma arc of the metal vapour is directed into the feedstock;
(c) the feedstock is heated with the plasma arc and the arcing material of the plasma arc, as a chemical reagent, is simultaneously brought into chemical reaction with the feedstock, wherein by means of the chemical reaction the metal content of the feedstock is freed, and at the same time the arcing material of the plasma arc is combined with the non-metallic constituents of the feedstock;
(d) the thus obtained substance containing the arcing material of the plasma arc is removed from the smelter through the gas off-take; and
(e) the metal content freed is let out from the smelter through the metal spout as a pure metal.

39. The extraction method of claim 38, characterized in that the activation energy of the chemical reaction taking place in step (c) is provided by the plasma arc.

40. The extraction method of claim 39, characterized in that through deoxidation of the metal oxides of the feedstock effected by the positively charged ions of the plasma arc, reduction of the metal oxides is accomplished.

41. The extraction method according to claim 38, characterized in that by subjecting the substance removed from the smelter in step (d) to further processing, an industrial feedstock is produced therefrom.

42. The extraction method of claim 41, characterized in that dried sodium hydroxide is produced as the industrial feedstock.

43. A method for destructing an organic matter, characterized in that the organic matter to be destroyed is interacted with the plasma arc of a plasma torch, wherein a vapour of at least one metal is used to form the plasma arc of the plasma torch.

44. The destruction method of claim 43, characterized in that a component is added to the plasma arc which during its conversion upon excitation emits an electromagnetic radiation breaking up the molecular bonds of the organic material to be destroyed.

45. The destruction method of claim 44, characterized in that a substance which emits intensive ultraviolet radiation during its conversion upon excitation is used as the component added.

46. The destruction method of claim 45, characterized in that a mercury containing compound, preferably mercury is added to the arcing material.

47. The plasma torch according to claim 24, characterized in that the frequency distribution of the electromagnetic spectrum of the arcing material in its excited state is continuous and characteristic of a black-body radiation.

48. The plasma torch according to claim 24, characterized in that the the first electrode comprises the arcing material and/or its compound(s).
